(19) United States
(12) Patent Application Publication
(10) Pub. No.: US 2024/0078781 A1
(43) Pub. Date: Mar. 7, 2024

(54) System and Method for Determining a Device Safe Zone

(71) Applicant: The Regents of The University of California, Oakland, CA (US)

(72) Inventors: Matthew S. Brown, Los Angeles, CA (US); Dieter R. Enzmann, Los Angeles, CA (US); Koon-Pong Wong, Los Angeles, CA (US); Jonathan G. Goldin, Los Angeles, CA (US); Fereidoun Abtin, Santa Monica, CA (US); Morgan Daly, Los Angeles, CA (US); Liza Shrestha, Los Angeles, CA (US)

(21) Appl. No.: 17/767,503

(22) PCT Filed: Oct. 12, 2020
(86) PCT No.: PCT/US2020/055271

§ 371 Date: Apr. 8, 2022

Related U.S. Application Data
(60) Provisional application No. 62/914,266, filed on Oct. 11, 2019.

(51) Int. Cl. G06V 10/25; G06V 10/82

(52) U.S. Cl. CPC G06V 10/25; G06V 10/82; G06V 2201/03

(57) ABSTRACT

A method for determining a region for safe placement of a device in a medical image includes receiving a medical image, detecting at least one anatomic landmark in the medical image using at least one deep convolutional neural network, determining the region for safe placement of the device based on the detected at least one anatomic region using a semantic network, and displaying the region for safe placement of a device on the medical image using a display.

### BACKGROUND

The present disclosure relates generally to image processing and detection and, more particularly, to a system and method for determining a region for safe placement of a medical device in a medical image.

A routine and significant radiologist interpretation task on medical images (e.g., chest x-rays) is the detection and placement checking of implanted man-made implantable devices such as tubes and lines. For example, chest x-rays may be used to confirm placement of life support tubes in patients. The presence and location of implantable man-made devices in medical images can be assessed visually by a radiologist. In addition, computer aided detection methods have been developed to assist in the detection and classification of medical devices in a medical image. Assessing the placement of medical devices on medical images is a difficult, time consuming task for radiologists and ICU personnel given the high volume of cases and the need for rapid interpretation. Incorrect placement of a device (e.g., a tube or line) that goes undetected can cause severe complications or even be fatal. For example, incorrect placement of the Endotracheal (ET) tube typically includes the tube being placed in the esophagus or in the soft tissue of the neck. In another example, incorrect placement of the Nasogastric (NG) tube includes the tube being placed in the pleural cavity. Placement of an NG tube in the pleural cavity can cause pneumothorax. Accordingly, detecting whether a device (e.g., a tube or line) is correctly placed is critical for patients including patients in ICUs.

It would be desirable to provide a system and method for determining whether a medical device is correctly placed using a medical image.

### SUMMARY OF THE DISCLOSURE

In accordance with an embodiment, a method for determining a region for safe placement of a device in a medical image includes receiving a medical image, detecting at least one anatomic landmark in the medical image using at least one deep convolutional neural network, determining the region for safe placement of the device based on the detected at least one anatomic region using a semantic network, and displaying the region for safe placement of a device on the medical image using a display.

In accordance with another embodiment, a system for determining a region for safe placement of a device in a medical image includes an input for receiving a medical image, at least one deep convolutional neural network coupled to the input and configured to analyze the medical image to detect at least one anatomic landmark in the medical image, a semantic network coupled to at least one deep convolutional neural network, the semantic network configured to determine the region for safe placement of the device based on the detected at least one anatomic region, and a display coupled to at least one deep convolutional neural network and the semantic network, the display configured to display the region for safe placement of a device on the medical image.

### BRIEF DESCRIPTION OF THE DRAWINGS

FIG. 1 illustrates a method for determining a region for safe placement of a device (a “Safe Zone”) in a medical image in accordance with an embodiment;

FIG. 2 is a schematic block diagram of a system for determining a region for safe placement of a device in a medical image in accordance with an embodiment;

FIG. 3 shows an example display of a device and a region for safe placement of the device on a medical image in accordance with an embodiment;

FIG. 4 shows an example display of a device and a region for safe placement of the device on a medical image in accordance with an embodiment; and

FIG. 5 is a block diagram of an example computer system that can implement the methods described herein in accordance with an embodiment.

### DETAILED DESCRIPTION

The present disclosure describes an automated system and method to define a region for safe device placement (or “Safe Zone”). The region for safe placement of a device may be displayed as an overlay on a patient image. The system may also be configured to generate an alert if the device is outside the Safe Zone. The Safe Zone is determined based on anatomic landmarks using machine learning, including deep learning. The system and method described herein utilizes one or more deep neural networks embedded within a semantic network, i.e., using a “semantically embedded neural network (SENN)” architecture. Each neural network may be trained to outline (segment) image regions (e.g., an anatomic landmark) from a large number of examples such as a set of training images. The semantic network allows explicit description (modeling) of object characteristics (such as size, shape, and intensity) and spatial relationships between objects based on prior knowledge. Thus, the semantic network can guide the neural network where to look in an image for a given object (e.g., an anatomic landmark) based on objects found already (i.e., helps the network to appropriately focus its attention), and can also ensure that the segmentation result from the neural network matches expected characteristics for that object. This increases the efficiency and reliability of the neural networks. The semantic network models the Safe Zone as an image region relative to the anatomic landmarks and enables the determination of the Safe Zone.

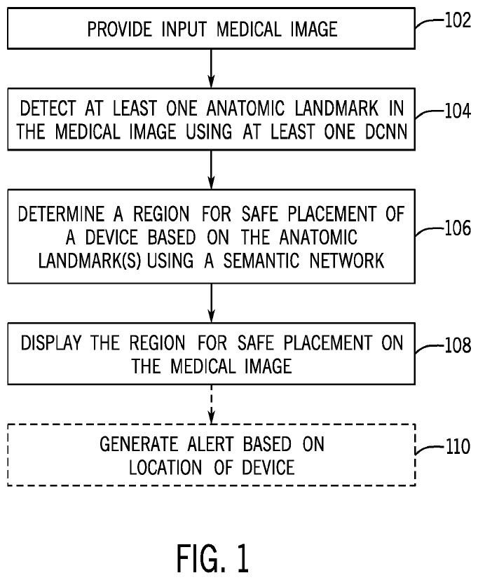

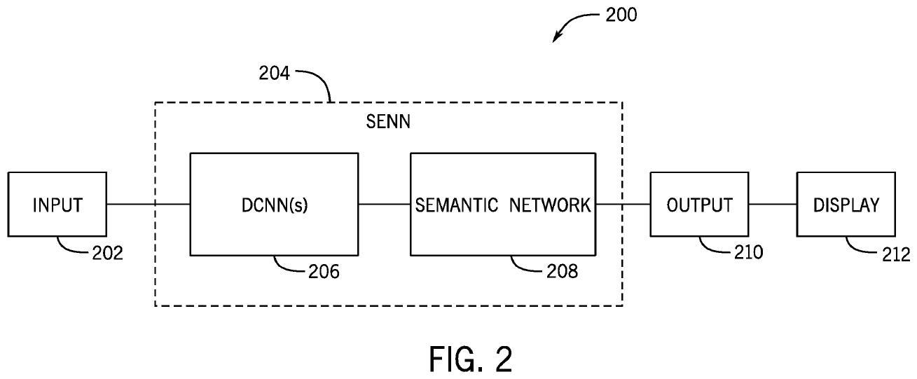

FIG. 1 illustrates a method for determining a region for safe placement of a device (a “Safe Zone”) in a medical image in accordance with an embodiment and FIG. 2 is a schematic block diagram of a system 200 for determining a region for safe placement of a device in a medical image in accordance with an embodiment. Referring to FIGS. 1 and 2, at block 102 a medical image is provided as input 202 to a semantically embedded neural network (SENN) 204 of the system 200. The medical image may be, for example, an x-ray or an image generated using other known imaging modalities. In one embodiment, the medical image may be pre-preprocessed before being input to the system. For example, the image may be rescaled or the image intensities may be normalized. The medical image may be associated with or stored in, for example, a hospital network. The medical image may be retrieved from, for example a picture archiving and communication system and may be, for example a DICOM (digital imaging and communication in medicine) image. In the embodiment shown in FIG. 2, the SENN 204 includes a deep convoluted neural network (DCNN) 206 and a semantic network 208. The medical image may be input to the DCNN 206. In one embodiment, the system includes one or more DCNNs 206 that are embedded in the semantic network 208. Each DCNN may be trained to segment one or more anatomic landmarks using known methods. In one example, the DCNN 206 may be trained using a data set of training images with manually segmented anatomic landmark(s) to segment or detect the anatomic landmark(s).

At block 104, the DCNN(s) 206 analyzes the input medical image to detect at least one anatomic landmark in the medical image. The output of the DCNN(s) 206 may be, for example, a binary mask representative of the anatomic landmark. In an embodiment with multiple DCNNs 206, each DCNN may be used to detect (or segment) different anatomic landmarks. At block 106, the semantic network 208 is then used to determine a region for safe placement of a device (“Safe Zone”) based on the anatomic landmarks. The semantic network models the Safe Zone as an image region relative to the anatomic landmarks and enables the determination of the Safe Zone. In one embodiment, the output 210 of the semantic network 208 may be, for example, a set of pixels (image region) representing the Safe Zone. At block 108, the Safe Zone is displayed on the medical image, for example, on a display device 212. The Safe Zone may be shown, for example as an overlay on the medical image. In an embodiment, different colors may be used to indicate whether the device is within or outside of the Safe Zone. For example, a green overlay color may be used to indicate the device (or a portion of the device) is within the Safe Zone and a red overlay color may be used to indicate if the device (or a portion of the device) is outside the Safe Zone and thus poses a risk to the patient.

In addition to the Safe Zone, the implanted device or a portion of the implanted device (e.g., a tip of the device) may also be shown with the Safe Zone on the medical image. Known methods for automatically detecting an implanted device on medical image may be used to detect and display the device on the medical image. In one embodiment, the system and method for automatically detecting man-made implanted devices is the system and method disclosed in U.S. Pat. No. 9,471,973, herein incorporated by reference in its entirety. In an embodiment, color codes and text labels may be used to distinguish different kinds of detected tubes and lines on a display of the patient image. The outputs from both systems may be combined to increase reliability. For example, if the two systems do not agree then the case will not be processed further and may be flagged as requiring review. In an embodiment, a measurement of the implanted device relative to an anatomic landmark may be used by a user to facilitate making an independent decision about correctness of device placement.

In another embodiment, the system and method disclosed herein may also be configured to, at block 110, generate an alert if the device is outside the Safe Zone. The alerts may be provided as banners with text that are displayed when a medical alert is detected by the system in language that conveys the type and level of urgency of the issue. For example, if the tip of the device (e.g., an endotracheal (ET) tube) is outside the Safe Zone, a default alert may indicate that the tip of the ET tube is “outside of the Safe Zone.” In other embodiments, more refined checks may also be performed and increased levels of urgency reported in the banner, for example, if the device (or a portion of the device) is outside a specific region of the Safe Zone, e.g., outside of one of the anatomic landmarks, the alert may indicate there is an immediate emergency and identify the specific region. The system may also be configured to accept external input that a tube/line is expected, for example, if the requisition indicates that the medical image is to check tube/line placement or if a tube/line was found on a recent prior medical image then the system can issue an alert if the tube/line is not found. Similarly, the system may issue alerts if the position of the device (or a portion of the device) has changed from the most recent medical image.

The disclosed system and method for determining a region for safe placement of an implantable device will now be described with respect to non-limiting examples. In one embodiment, the disclosed system and method may be used in conjunction with the placement of endotracheal (ET) tubes on chest x-ray images. Based on medical literature, the tip of the ET tube should be placed about 5 to 7 cm above the carina (minimal safe distance: 2 cm) or roughly in the middle section of the trachea. Therefore, the trachea and carina are key anatomic landmarks in determining the ET tube Safe Zone. As discussed above, the landmarks may be segmented automatically using one or more trained deep convolutional neural networks (DCNNs). The trained DCNNs are embedded within a semantic network that models the Safe Zone as an image region relative to the anatomic landmarks (trachea and carina) and enables the determination of the Safe Zone. For example, a DCNN may be provided to segment the trachea and a different DCNN may be used to segment the carina.

In this example, automatic trachea segmentation may be performed using the U-Net deep convolutional neural network (DCNN) architecture. Before being input to the network, a chest x-ray undergoes pre-processing as follows: (1) it is rescaled to 512×512×1 pixels, (2) image intensities are normalized to a mean of 0 and standard deviation of 1. The U-Net is made up of 5 encoder and 5 decoder blocks. Each encoder block takes an input and applies two 3×3 convolution layers followed by a 2×2 max pooling. Each decoder block applies a 3×3 convolution layer followed by 2×2 upsampling. Rectified Linear Unit (ReLu) may be used as the activation function in all encoder and decoder blocks except for the bottommost layer. The bottommost layer may mediate between the encoder and the decoder. In addition, it may use on 3×3 convolution layer and sigmoid as activation function. In this example, the DCNN was trained on a data set of chest x-rays with manually segmented tracheas. The loss was measured in terms of Dice coefficient and the Adam optimization algorithm was used with a learning rate of 0.00005. The DCNN output was a binary mask representative of the trachea (512×512×1) which was then spatially rescaled to the original input image dimensions.

In this example, carina localization or segmentation may be performed using a regression predictive model based on the VGGNet deep convolutional neural network (DCNN) architecture. Before being put to the network, a chest x-ray may undergo pre-processing as follows: (1) it is rescaled to 512×512×1 pixels, (2) the contrast is enhanced to improve conspicuity of the trachea using contrast limited adaptive histogram equalization, (3) image intensities are normalized to a mean of 0 and standard deviation of 1. The DCNN is made up of five blocks with a total of 16 weight layers. The first four blocks consist of convolutional layers followed by a max pooling layer, and the fifth block consists of convolutional layers followed by three fully connected layers. A receptive field size of 3×3 is used in all convolutional layers. Dropout is used after the first four blocks with a fraction of 0.5. The DCNN output is a 2×1 array of points representing the spatial location (coordinates) of the carina which are spatially rescaled to the original input image dimensions.

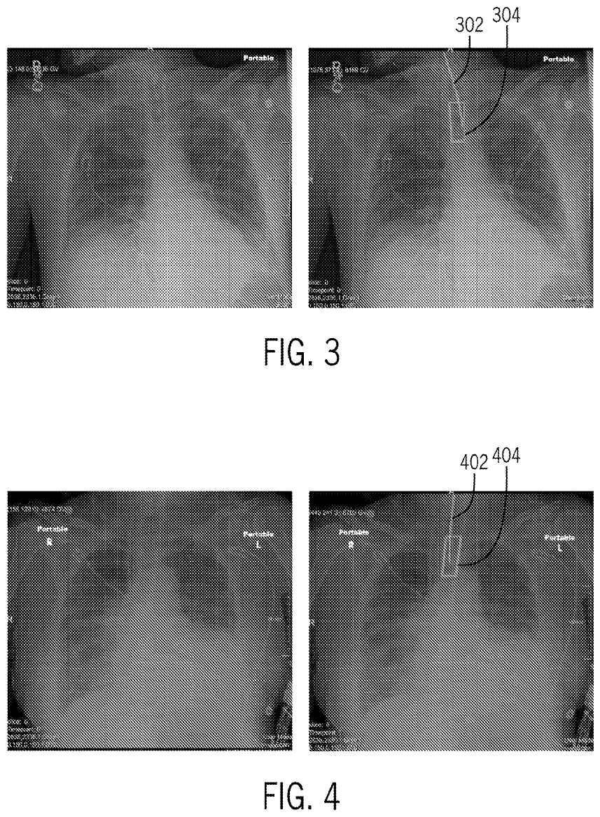

In this example, the semantic network may be configured to define spatial relationships of the ET Tube Safe Zone relative to detected anatomic landmarks, namely, the trachea and carina. The semantic network may be configured to describe two regions within the trachea. One 7 cm above the carina, and the other 2 cm above the carina. In this example, the semantic network then modeled the ET Tube Safe Zone as the convex hull of these two regions, i.e., a trapezoidal that encloses the two regions. In another embodiment, a measurement from the ET tip to the carina can be shown, or measurement tick marks displayed above the carina. Example images outputted by the system for determining a Safe Zone in conjunction with a system for detecting a device on a medical image are shown in FIGS. 3 and 4. In FIGS. 3 and 4, overlays on a chest x-ray show automatically detected ET tubes 302, 402 and Safe Zones 304, 404 for tube tip location. As mentioned above, different colors may be used for the device and Safe Zones to indicate whether the device or a portion of the device (e.g., a tube tip) is within the Safe Zone 304, 404.

As discussed above, the disclosed system and method may be configured to generate an alert if the device is outside the Safe Zone. In an embodiment, the alerts may be banners with text that are displayed when a medical alert is detected by the system in language that conveys the type and level of urgency of the issue. For example, if the tip of the ET tube is outside the Safe Zone the default alert may indicate that the tip of the ET tube is “outside of the Safe Zone.” However, more refined checks may also be performed and increased levels of urgency reported in the banner as follows: (a) if the tip is outside the trachea” “immediate emergency—ET tube outside the trachea”; (b) if the tip is beyond the carina: “immediate emergency—ET tube beyond the carina”. The system may also be configured to accept external input that a tube/line is expected, for example, if the requisition indicates that the x-ray is to check tube/line placement or if a tube/line was found on a recent prior x-ray then the system can issue an alert if the tube/line is not found. Similarly, the system may issue alerts if the position of the tip is changed from the most recent prior x-ray.

In another embodiment, the disclosed system and method may be used in conjunction with the placement of nasogastric (NG) tubes on chest x-ray images. In this example, the NG tube Safe Zone may be identified using a similar SENN approach, based on the knowledge that ideally the NG tube tip should be visible below the diaphragm and on the left side of the abdomen, 10 cm or more beyond the gastro-esophageal junction. Therefore, the gastroesophageal junction and left costophrenic angle are the anatomic landmarks used to define this Safe Zone. These two landmarks are detected as points in the image using DCNNs, similar to that described above for the carina to automatically determine their coordinates. The semantic network then defines the NG Tube Safe Zone as a region relative to those landmarks.

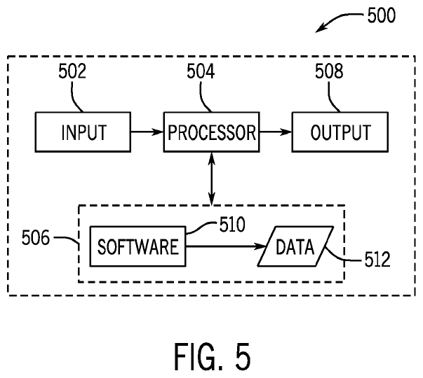

FIG. 5 is a block diagram of an example computer system that can implement the methods and systems described herein in accordance with an embodiment. The computer system 500 generally includes an input 502, at least one hardware processor 504, a memory 506, and an output 508. Thus, the computer system 500 is generally implementer with a hardware processor 504 and a memory 506. In come embodiments, the computer system 500 may be a workstation, a notebook computer, a tablet device, a mobile device, a multimedia device, a network server, a mainframe, one or more controller, one or more microcontrollers, or any other general-purpose or application-specific computing device.

The computer system 500 may operate autonomously or semi-autonomously, or may read executable software instructions from memory 506 or a computer-readable medium (e.g., hard drive a CD-RIOM, flash memory), or may receive instructions via the input from a user, or any other source logically connected to a computer or device, such as another networked computer or server. Thus, in come embodiments, the computer system 500 can also include any suitable device for reading computer-readable storage media. In general, the computer system 500 may be programmed or otherwise configured to implement the methods and algorithms described in the present disclosure.

The input 502 may take any suitable shape or form, as desired, for operation of the computer system 500, including the ability for selecting, entering, or otherwise specifying parameters consistent with performing tasks, processing data, or operating the computer system 500. In some aspects, the input 502 may be configured to receive data, such as medical images. In addition, the input 502 may also be configured to receive any other data or information considered useful for implementing the methods described above. Among the processing tasks for operating the computer system 500, the one or more hardware processors 504 may also be configured to carry out any number of post-processing steps on data received by way of the input 502.

The memory 506 may contain software 510 and data 512, such as imaging data, clinical data and molecular data, and may be configured for storage and retrieval of processed information, instructions, and data to be processed by the one or more hardware processors 504. In some aspects, the software 510 may contain instructions directed to implementing one or more machine learning algorithms with a hardware processor 504 and memory 506. In addition, the output 508 may take any form, as desired, and may be, for example, a display configured for displaying images, overlays of a device or a Safe Zone on an image, patient information, and reports, in addition to other desired information. Computer system 500 may also be coupled to a network 514 using a communication link 516. The communication link 516 may be a wireless connection, cable connection, or any other means capable of allowing communication to occur between computer system 500 and network 514.

Computer-executable instructions for determining a region for safe placement of a device (a “Safe Zone”) in a medical image according to the above-described methods may be stored on a form of computer readable media. Computer readable media includes volatile and nonvolatile, removable, and non-removable media implemented in any method or technology for storage of information such as computer readable instructions, data structures, program modules or other data. Computer readable media includes, but is not limited to, random access memory (RAM), read-only memory (ROM), electrically erasable programmable ROM (EEPROM), flash memory or other memory technology, compact disk ROM (CD-ROM), digital volatile disks (DVD) or other optical storage, magnetic cassettes, magnetic tape, magnetic disk storage or other magnetic storage devices, or any other medium which can be used to store the desired instructions and which may be accessed by a system (e.g., a computer), including by internet or other computer network form of access.

The present invention has been described in terms of one or more preferred embodiments, and it should be appreciated that many equivalents, alternatives, variations, and modifications, aside from those expressly states, are possible and within the scope of the invention.

1. A method for determining a region for safe placement of a device in a medical image, the method comprising:
receiving a medical image;
detecting at least one anatomic landmark in the medical image using at least one deep convolutional neural network;
determining the region for safe placement of the device based on the detected at least one anatomic region using a semantic network; and
displaying the region for safe placement of a device on the medical image using a display.

2. The method according to claim 1, wherein the medical image is an x-ray.

3. The method according to claim 1, wherein the at least one deep convolutional neural network is embedded in the semantic network.

4. The method according to claim 1, wherein the output of the at least one deep convolutional neural network is a binary mask representation of the at least one anatomic landmark.

5. The method according to claim 1, wherein the output of the semantic network is a set of pixels representing the region for safe placement of the device.

6. The method according to claim 1, wherein the semantic network is configured to model the region for safe placement of the device as an image region relative to the at least one anatomic region.

7. The method according to claim 6, wherein the semantic network is configured to define a spatial relationship of the device relative to the detected at least one anatomic region.

8. The method according to claim 1, further comprising generating an alert based on the whether the device is located within the region for safe placement of the device.

9. The method according to claim 9, wherein the alert is displayed on the display.

10. The method according to claim 1, further comprising:
detecting a location of the device on the medical image; and
displaying a representation of the device on the medical image on the display.

11. A system for determining a region for safe placement of a device in a medical image, the system comprising:
an input for receiving a medical image;
at least one deep convolutional neural network coupled to the input and configured to analyze the medical image to detect at least one anatomic landmark in the medical image;
a semantic network coupled to at least one deep convolutional neural network, the semantic network configured to determine the region for safe placement of the device based on the detected at least one anatomic region; and
a display coupled to the at least one deep convolutional neural network and the semantic network and configured to display the region for safe placement of a device on the medical image.

12. The system according to claim 11, wherein the display is further configured to display an associated measurement of the medical image.

13. The system according to claim 11, wherein the medical image is an x-ray.

14. The system according to claim 11, wherein the at least one deep convolutional neural network is embedded in the semantic network.

15. The system according to claim 11, wherein the output of the at least one deep convolutional neural network is a binary mask representation of the at least one anatomic landmark.

16. The system according to claim 11, wherein the output of the semantic network is a set of pixels representing the region for safe placement of the device.

17. The system according to claim 11, wherein the semantic network is configured to model the region for safe placement of the device as an image region relative to the at least one anatomic region.

18. The system according to claim 17, wherein the semantic network is configured to define a spatial relationship of the device relative to the detected at least one anatomic region.

19. The system according to claim 11, wherein the display is further configured to generate an alert based on the whether the device is located within the region for safe placement of the device.
